(19) United States
(12) Patent Application Publication
(10) Pub. No.: US 2024/0190080 A1
(43) Pub. Date: Jun. 13, 2024

(54) PARTITIONING 3D MODELS OF COMPONENTS

(71) Applicant: Hewlett-Packard Development Company, L.P., Spring, TX (US)

(72) Inventors: Lluis PARE BARNIOL, Sant Cugat del Valles (ES); Oriol BORRELL CARBONELL, Sant Cugat del Valles (ES); Daniel Alejandro POVEDA PI, Sant Cugat del Valles (ES)

(21) Appl. No.: 18/286,128

(22) PCT Filed: Apr. 13, 2021
(86) PCT No.: PCT/US2021/027102

§ 371 Date: Oct. 8, 2023

(51) Int. Cl. B29C 64/393; B33Y 10/00; B33Y 50/02

(52) U.S. Cl. CPC B29C 64/393; B33Y 10/00; B33Y 50/02

(57) ABSTRACT

According to examples, a non-transitory computer-readable medium may have stored thereon instructions that may cause a processor to obtain a three-dimensional (3D) model of a component to be fabricated by a 3D fabrication system, the 3D fabrication system having a build volume. The processor may also determine, based on a set of factors, a partitioning of the 3D model into separate sections, in which the separate sections may correspond to portions of the component that are sized to be fabricated within the build volume. The processor may further modify the 3D model to model the component as the separate sections.

### BACKGROUND

Various types of products may be fabricated from a pulp of material. Particularly, a pulp molding die that includes a forming mold and a screen may be immersed in the pulp of material and the material in the pulp may form into the shape of the forming mold and the screen. The forming mold and the screen may have a desired shape of the product to be formed. The forming mold and the screen may include numerous pores for liquid passage, in which the pores in the screen may be significantly smaller than the pores in the forming mold. During formation of the product, a vacuum force may be applied through the pulp molding die which may cause some of the material in the pulp to be suctioned onto the screen and form into a shape that matches the shape of the pulp molding die. The material may be removed from the screen and may be solidified, for example through drying, to have the desired shape.

### BRIEF DESCRIPTION OF THE DRAWINGS

Features of the present disclosure are illustrated by way of example and not limited in the following figure(s), in which like numerals indicate like elements, in which:

FIG. 1 shows a block diagram of an example computer-readable medium that may have stored thereon computer-readable instructions for partitioning a three-dimensional (3D) model of a component of a molded fiber toolset and modifying the 3D model to model the component as separate sections;

FIG. 2 shows a diagram, which includes an example processor that may execute the computer-readable instructions stored on the example computer-readable medium depicted in FIG. 1 to partition and the 3D model of the component;

FIGS. 3A and 3B, respectively, depict cross-sectional side views of an example forming tool and an example transfer tool;

FIG. 3C shows a cross-sectional side view of the example forming tool and the example transfer tool depicted in FIGS. 3A and 3B during a removal by the example transfer tool of the wet part from the example forming tool;

FIG. 3D shows an enlarged cross-sectional view of a section of the example transfer tool shown in FIG. 3B;

FIG. 4 shows a diagram of an example platen upon which a forming tool or a transfer tool depicted in FIGS. 3A-3C may be mounted;

FIG. 5 shows a diagram of an example 3D model that may have a closed loop partition; and

FIG. 6 shows a flow diagram of an example method for partitioning a 3D model of a component of a molded fiber toolset and modifying the 3D model to model the component as separate sections.

### DETAILED DESCRIPTION

For simplicity and illustrative purposes, the present disclosure is described by referring mainly to examples. In the following description, numerous specific details are set forth in order to provide a thorough understanding of the present disclosure. It will be readily apparent however, that the present disclosure may be practiced without limitation to these specific details. In other instances, some methods and structures have not been described in detail so as not to unnecessarily obscure the present disclosure.

Throughout the present disclosure, the terms “a” and “an” are intended to denote at least one of a particular element. As used herein, the term “includes” means includes but not limited to, the term “including” means including but not limited to. The term “based on” means based at least in part on.

Three-dimensional (3D) fabrication systems may fabricate parts within respective build volumes. In instances in which a part is larger than the build volume of a 3D fabrication system, the 3D fabrication system may be unable to fabricate the part within the build volume. Disclosed herein are computer-readable media, methods, and apparatuses, in which a processor may determine, based on a set of factors, how a 3D model of a component is to be partitioned such that the portions of the component corresponding to the partitioned sections may be fabricated within a build volume of a 3D fabrication system. The component may be a component of a molded fiber toolset, such as a forming mold, a forming screen, a transfer mold, or a transfer screen.

As discussed herein, the processor may determine a location, or locations, at which the component may be partitioned into portions of the component. The processor may make this determination based on a consideration of a set of factors directed to the component, the 3D fabrication system, other components, and/or the like. In some examples, the processor may determine the manner in which the component may be partitioned to be a manner that may result in a maximized compliance with the factors. In addition, the processor may modify the 3D model by partitioning the 3D model to have sections that correspond to the partitioned portions of the component. As a result, the 3D fabrication system may fabricate the portions of the component within the build volume based on the 3D model, or a print-ready version of the 3D model, having the sections.

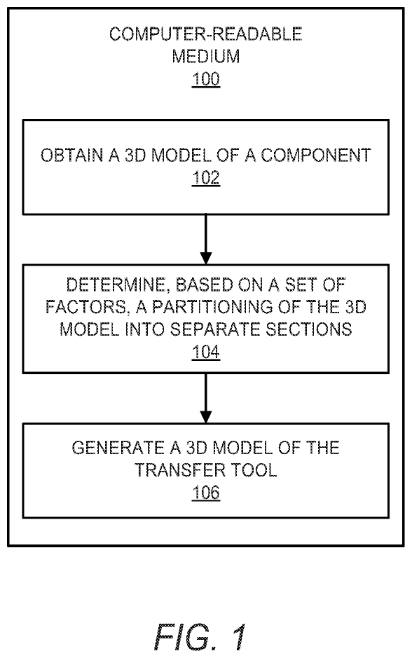

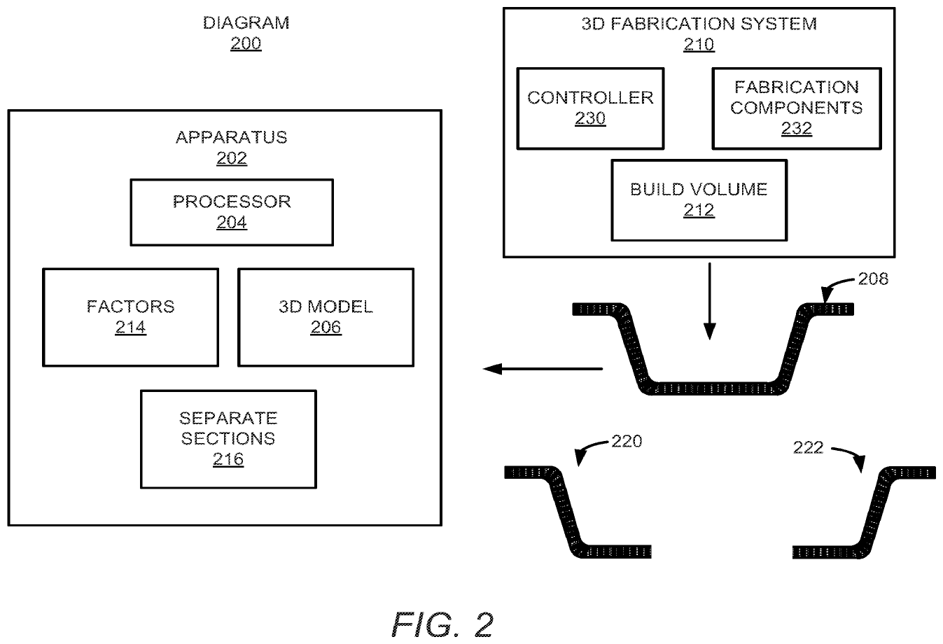

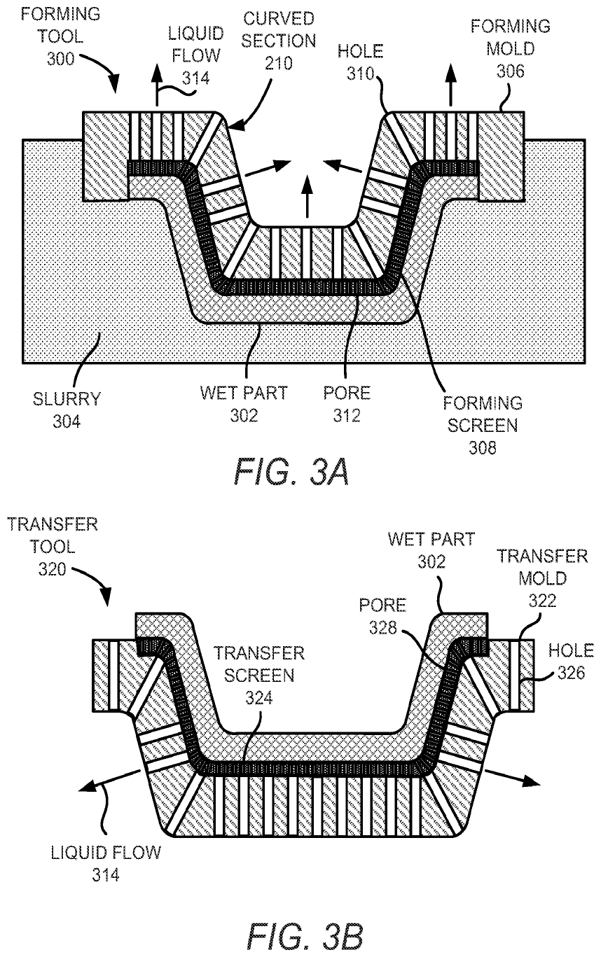

Reference is first made to FIGS. 1, 2, and 3A-3C. FIG. 1 shows a block diagram of an example computer-readable medium 100 that may have stored thereon computer-readable instructions for partitioning a 3D model 206 of a component 208 of a molded fiber toolset and modifying the 3D model 206 to model the component 208 as separate sections 216. FIG. 2 shows a diagram 200, which includes an example processor 204 that may execute the computer-readable instructions stored on the example computer-readable medium 100 to partition and modify the 3D model 206 of the component 208. FIGS. 3A and 3B, respectively, depict cross-sectional side views of an example forming tool 300 and an example transfer tool 320 and FIG. 3C shows a cross-sectional side view of the example forming tool 300 and the example transfer tool 320 during a removal by the example transfer tool 320 of a wet part 302 from the example forming tool 300.

It should be understood that the example computer-readable medium 100 depicted in FIG. 1, the example processor 204 depicted in FIG. 2, and/or the example forming tool 300 and the example transfer tool 320 respectively depicted in FIGS. 3A-3C may include additional attributes and that some of the attributes described herein may be removed and/or modified without departing from the scopes of the example computer-readable medium 100, the example processor 204, and/or the example forming tool 300 and the example transfer tool 320.

The computer-readable medium 100 may have stored thereon computer-readable instructions 102-106 that a processor, such as the processor 204 depicted in FIG. 2, may execute. The computer-readable medium 100 may be an electronic, magnetic, optical, or other physical storage device that contains or stores executable instructions. The computer-readable medium 100 may be, for example, Random Access memory (RAM), an Electrically Erasable Programmable Read-Only Memory (EEPROM), a storage device, an optical disc, and the like. Generally speaking, the computer-readable medium 100 may be a non-transitory computer-readable medium, in which the term “non-transitory” does not encompass transitory propagating signals.

The processor 204 may fetch, decode, and execute the instructions 102 to obtain a 3D model 206 of a component 208 to be fabricated by a 3D fabrication system 210. The 3D fabrication system 210 may include a build volume 212, in which the build volume 212 may equivalently be termed a build bucket or the like. The build volume 212 may be the volume within which the 3D fabrication system 210 may fabricate parts and may define the maximum size that a part formed by the 3D fabrication system 210 may have. The build volume 212 may differ for different types of 3D fabrication systems 210 as well as 3D fabrication systems 210 having different sizes.

The 3D fabrication system 210 may be any suitable type of additive manufacturing system. Examples of suitable additive manufacturing systems may include systems that may employ curable binder jetting onto build materials (e.g., thermally or UV curable binders), print agent jetting onto build materials (e.g., fusing and/or detailing agents), selective laser sintering, stereolithography, fused deposition modeling, etc. In a particular example, the 3D fabrication system 210 may fabricate the component 208 by binding and/or fusing build material particles together. In any of these examples, the build material particles may be any suitable type of material that may be employed in 3D fabrication processes, such as, a metal, a plastic, a nylon, a ceramic, a polymeric material, an alloy, and/or the like.

The component 208 may be a component of a molded fiber toolset. As shown in FIGS. 3A-3C, the molded fiber toolset may include a forming tool 300 and a transfer tool 320. In addition, the forming tool 300 may include a forming mold 306 and a forming screen 308 and the transfer tool 320 may include a transfer mold 322 and a transfer screen 324, while in some examples, the transfer tool 320 may not include the transfer screen 324. The forming screen 308 may be mounted to the forming mold 306 directly and/or via an external support member (not shown). Likewise, the transfer screen 324 may be mounted to the transfer mold 322 directly and/or via an external support member (not shown). The component 208 may be any of the forming mold 306, the forming screen 308, the transfer mold 322, and the transfer screen 324. In the example shown in FIG. 2, the component 208 is depicted as a forming screen 308 or a transfer screen 324.

The 3D model 206 may be a computer aided design (CAD) file, or other digital representation of the component 208 such as a 3D manufacturing format (3MF) file, an STL file, or the like. In addition, the processor 204 may obtain the 3D model 206 from a local data store (not shown) or from an external source, e.g., via the Internet. The processor 204 may also store the 3D model 206 in the local data store.

The processor 204 may fetch, decode, and execute the instructions 104 to determine, based on a set of factors 214, a partitioning of the 3D model 206 into separate sections 216. The separate sections 216 may correspond to portions 220, 222 of the component 208, in which the portions 220, 222 may be sized to be respectively or concurrently fabricated within the build volume 212 of the 3D fabrication system 210. That is, the separate sections 216 may correspond to portions 220, 222 of the component 208 that may be sized to be fabricated within the build volume 212 during a common fabrication operation, e.g., together within the build volume 212. In other instances, the portions 220, 222 of the component 208 may be sized to be fabricated during separate fabrication operations, e.g., one after the other. Although particular reference is made herein to the 3D model 206 being partitioned into two separate sections 216, it should be understood that the features disclosed herein may be applied to partition the 3D model 206 into any number of sections 216.

In some examples, the processor 204 may determine whether the 3D fabrication system 210 is able to fabricate the component 208 as a whole within the build volume 212. The processor 204 may also determine the partitioning of the 3D model 206 into the separate sections that correspond to the portions 220, 222 based on a determination that the 3D fabrication system 210 is unable to fabricate the component 208 as a whole within the build volume 212.

The processor 204 may determine how the 3D model 206 is to be partitioned into the separate sections 216 corresponding to the portions 220, 222 of the component 208 while maximizing compliance with the set of factors 214. For instance, the processor 204 may determine a partitioning of the 3D model 206 that may result in the portions 220, 222 complying with a maximum number of the set of factors 214. In some examples, the set of factors 214 may follow a hierarchy of importance such that some of the factors 214 may have greater importance than other ones of the factors 214. In these examples, the processor 204 may determine a partitioning of the 3D model 206 that may result in the portions 220, 222 complying with a maximum number of the highest ranked ones of the set of factors 214 according to the hierarchy of the factors 214. Similarly to the hierarchy, the factors 214 may be assigned various weights such that some of the factors 214 may be weighted higher than other ones of the factors 214.

The set of factors 214 may be directed or otherwise correspond to the component 208. For instance, the factors 214 may correspond to a shape, e.g., the complexity of certain areas, of the component 208, locations of structural features such as pores, holes, pillars, a manner in which the portions 220, 222 of the component 208 may be attached to each other, etc. In these examples, the processor 204 may determine the partitioning of the 3D model 206 into the separate sections 216 such that the portions 220, 222 corresponding to the sections 216 may be attached to each other to form the component 208 with minimal disruption to the functionality of the component 208, with minimal disruption to an aesthetic quality of the component 208, with minimal disruption to the ability of the portions 220, 222 to be attached to each other, and/or the like. The processor 204 may also determine the partitioning of the 3D model 206 into the separate sections 216 such that the remnants of a slurry 304 may be removed from the component 208 fabricated from the portions 220, 222 corresponding to the separate sections 216 during cleaning of the component 208.

In some examples, the processor 204 may obtain a second 3D model of a second component of the molded fiber toolset to be fabricated by the 3D fabrication system 210, in which the second component may be mounted to the component 208. In these examples, the second component may be a forming mold 306 or a transfer mold 322 and the component 208 may be a forming screen 308 or a transfer screen 324, which may be mounted to the second component. In addition, the processor 204 may determine a partitioning of the second 3D model into second separate sections based on the set of factors 214. The set of factors 214 may include a restriction on the partitioning of the second 3D model based on the partitioning of the 3D model 206. The restriction may include a restriction that the locations along the component 208 at which the component 208 is partitioned may not overlap with the locations along the second component at which the second component is partitioned when the component 208 is mounted to the second component.

The set of factors 214 may also or alternatively be directed to otherwise correspond to a type of the slurry 304 from which the molded fiber toolset is to form fiber parts. The processor 204 may determine the partitioning of the 3D model 206 into the separate sections 216 such that the junction at which the portions 220, 222 corresponding to the separate sections 216 are attached to each other to form the component 208 may not result in adverse part formation areas. As different types of slurries 304 may build up differently on a forming tool 300, partitioning at various locations of the component 208 may have different effects on the part formed from the slurries 304.

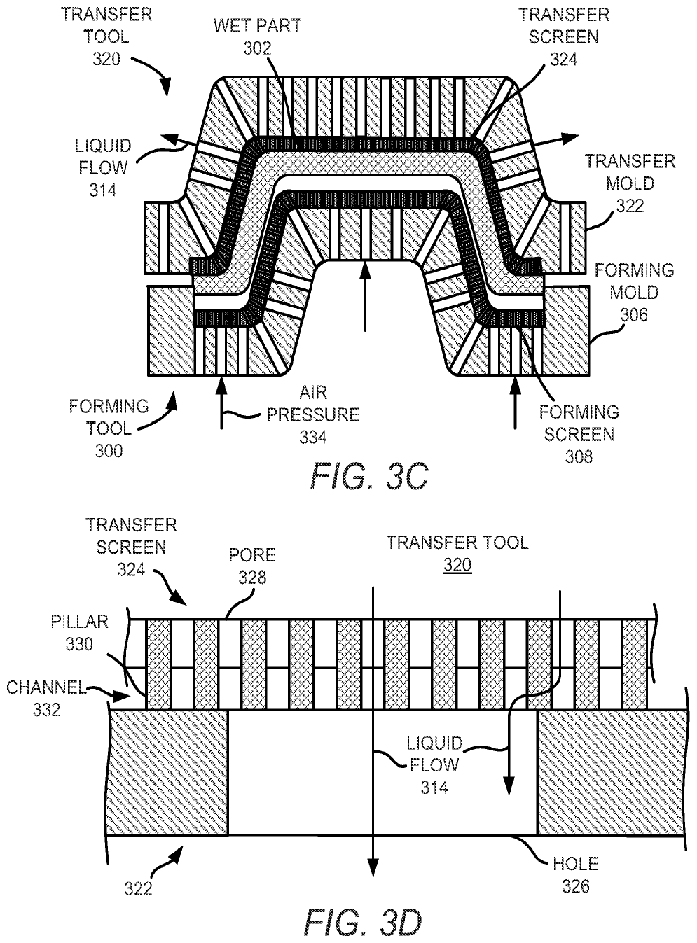

The set of factors 214 may also or alternatively be directed to otherwise correspond to a mounting platen upon which the forming tool 300 or the transfer tool 320 is to be mounted. A diagram of an example platen 400 is depicted in FIG. 4. As shown in FIG. 4, the platen 400 may include bolting holes 402 to which the forming tool 300 or the transfer tool 320 may be secured. The platen 400 may also include suction windows 404 through which air and/or liquid may flow to or from the forming tool 300 or transfer tool 320 mounted on the platen 400. In these examples, the processor 204 may determine the partitioning of the 3D model 206 such that a location of the partition of the component 208 is not positioned directly over one of the bolting holes 402. As another example, the processor 204 may determine the partitioning of the 3D model 206 such that features, such as welds, ribs, adhesives, etc., that may be used to attach the portions 220, 222 may not significantly block the suction windows 404.

The set of factors 214 may also or alternatively be directed to or otherwise correspond to an ability of the portions 220, 222 to be fabricated in a nesting arrangement within the build volume 212. For instance, the processor 204 may determine the partitioning of the 3D model 206 such that both of the portions 220, 222 corresponding to the sections 216 of the 3D model 206 may be fabricated with certain nested orientations within the build volume 212. In other words, the processor 204 may not determine the partitioning of the 3D model 206 to result in the portions 220, 222 being unable to be fabricated during a common fabrication cycle within the build volume 212.

The set of factors 214 may also or alternatively be directed to or otherwise correspond to a shape of the partition. The shape of the partition may be a one-dimensional shape, e.g., a linear shape, a curvilinear shape, a stepped shape, a circular shape, and/or the like. By way of example, the processor 204 may attempt to partition the 3D model 206 such that the partition is linear. If this attempt is unsuccessful because, for instance, doing so may violate another factor 214, the processor 204 may attempt to partition the 3D model 206 such that the partition is curvilinear or to have another shape. The processor 204 may cause the partition to have a certain shape that may maximize compliance with the factors 214, e.g., maximize compliance with a majority of the factors 214, maximize compliance with the highest ranked factors 214, and/or the like.

The processor 204 may split the 3D model 206 along a line across a width or length of the 3D model 206 such that the partition extends vertically through the 3D model 206. In other instances, the processor 204 may split the 3D model 206 to cause the partition to extend horizontally through the 3D model 206 or at any other angle.

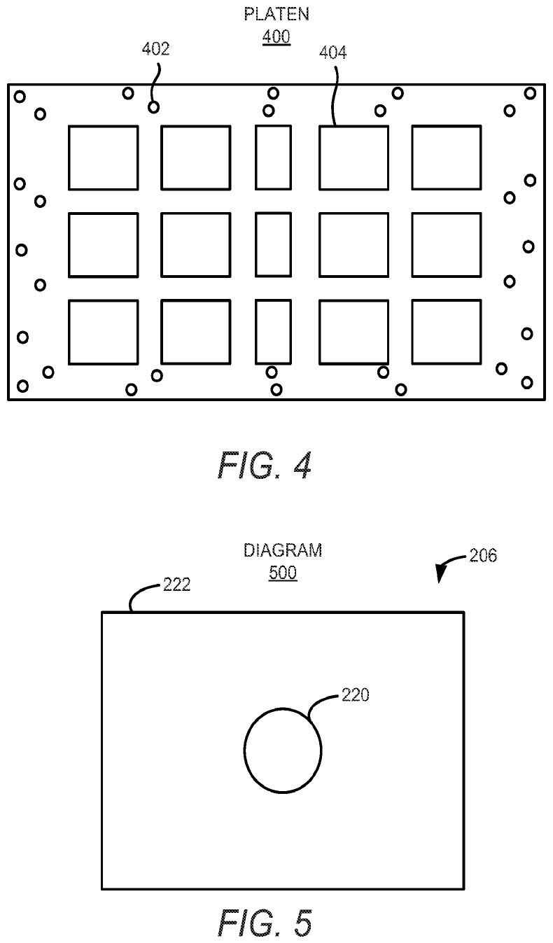

According to examples, the shape of the partition may be a closed loop, such as a circular loop, a rectangular loop, a polygonal loop, and/or the like. A diagram 500 of this type of partition is depicted in FIG. 5, which shows a diagram of an example 3D model 206 having a partition 502 that has a circular shape. In these examples, the 3D model 206 may be partitioned such that a corresponding first portion 220 may be formed within the corresponding second portion 222. These examples may be employed to enable different versions of the first portion 220 to be used with a common second portion 222. For instance, each of a number of different versions of the first portion 220 may include a different logo. Thus, in order to change the logo that is formed on a fiber part by the component 208, the first portion 220 may be replaced while the same second component portion may be used for the different versions of the first portion 220.

The processor 204 may fetch, decode, and execute the instructions 106 to modify the 3D model 206 to model the component 208 as the separate sections 216. That is, the processor 204 may split the 3D model 206 to include separate 3D models 206, one to correspond to the first portion 220 and the other to correspond to the second portion 222. This may include, for instance, modifying a CAD file, a 3MF file, and/or the like. In some examples, the processor 204 may convert the modified 3D model 206 to be in a format that the 3D fabrication system 210 may use to fabricate the first and second portions 220, 222. In some examples, the processor 204 may be part of or may otherwise control fabrication components of the 3D fabrication system 210 to fabricate the portions 220, 222. In other examples, the processor 204 may send the 3D model 206 to the 3D fabrication system 210 and a controller or processor of the 3D fabrication system 210 may convert the 3D model 206 into a print ready file, such as by voxelizing the 3D model 206.

As shown in FIG. 2, the 3D fabrication system 210 may additionally include a controller 230 and fabrication components 232. The controller 230 may be equivalent to the processor 204 or may be a separate controller of the 3D fabrication system 210. The controller 230 may receive the 3D model 206, which may include sections 216 representing portions 220, 222 of a component 208 of a molded fiber toolset, in which the sections 216 representing the portions of the component were partitioned to maximize compliance with a set of factors corresponding to the molded fiber toolset. In addition, the controller 230 may control the fabrication components to fabricate the portions of the component separately from each other within the build volume based on the received 3D model, in which the portions of the component are to be attached to each other to form the component of the molded fiber toolset following fabrication of the portions 220, 222. Prior to controlling the fabrication components 232, the controller 230 may convert the 3D model 206 to be in a print-ready format.

The controller 230 may also receive a second 3D model including second sections representing second portions of a second component of the molded fiber toolset that is to be mounted to the component 208. In addition, a partition location of the second portions do not overlap with a partition location of the portions of the component when the second component is mounted to the component. That is, the partition location of the second portions may be determined to be a location that does not overlap with the partition location of the portions 220, 222 when the second component is mounted to the component 208.

According to examples, the processor 204 may determine a plurality of candidate partitioning locations of the 3D model 206 based on the set of factors 214. For instance, the processor 204 may determine a number of candidate partitioning locations, e.g., around 3, 4, or 5, etc., locations, that may maximize compliance with the factors 214 equally or within a predefined level of deviation with respect to each other. The processor 204 may also output the determined plurality of candidate partitioning locations. For instance, the processor 204 may cause the plurality of candidate partitioning locations to be provided to a user such that the user may select a preferred one of the plurality of candidate partitioning locations. The preferred one may be based on functional and/or aesthetic considerations by the user. In addition, the processor 204 may receive a selection of one of the plurality of candidate partitioning locations and may modify the 3D model 206 of the component 208 according to the received selection.

In some examples, the processor 204 may be part of an apparatus 202, which may be a computing system such as a server, a laptop computer, a tablet computer, a desktop computer, or the like. In other examples, the processor 204 may be part of the 3D fabrication system 210. In either of these examples, the processor 204 may be a semiconductor-based microprocessor, a central processing unit (CPU), an application specific integrated circuit (ASIC), a field-programmable gate array (FPGA), and/or other suitable hardware device. The apparatus 202 may also include a memory that may have stored thereon computer-readable instructions (which may also be termed computer-readable instructions) that the processor 204 may execute. The memory may be an electronic, magnetic, optical, or other physical storage device that contains or stores executable instructions. The memory may be, for example, Random Access memory (RAM), an Electrically Erasable Programmable Read-Only Memory (EEPROM), a storage device, an optical disc, and the like. The memory, which may also be referred to as a computer-readable storage medium, may be a non-transitory computer-readable storage medium, where the term “non-transitory” does not encompass transitory propagating signals.

The apparatus 202 may include a memory on which is stored instructions that the processor 204 may execute. The memory may be the computer-readable medium 100 depicted in FIG. 1. In this regard, the processor 204 may execute instructions to obtain a 3D model 206 of a component 208 of a molded fiber toolset to be fabricated by a 3D fabrication system 210. The instructions may cause the processor 204 to identify a build volume 212 of the 3D fabrication system 210. The processor 204 may make this identification from data received regarding the 3D fabrication system 210.

The instructions may cause the processor 204 to determine whether the component 208 is able to be fabricated within the identified build volume 212 as a complete component. That is, the processor 204 may determine whether the build volume 212 of the 3D fabrication system 210 is insufficiently large to accommodate fabrication of the component 208 without partitioning the component 208. The instructions may cause the processor 204 to, based on a determination that the component 208 is not able to be fabricated within the identified build volume 212 as a complete component, determine how the 3D model 206 is to be partitioned into separate sections 216 while maximizing compliance with a set of factors 214 corresponding to the molded fiber toolset. As discussed herein, the separate sections 216 may correspond to portions 220, 222 of the component 208 that are sized to be fabricated within the identified build volume 212 of the 3D fabrication system 210. The instructions may cause the processor 204 to modify the 3D model 206 to model the component 208 as the separate sections 216 such that the portions 220, 222 corresponding to the sections 216 in the 3D model 206 may be fabricated as separate elements.

Particular reference is now made to FIGS. 3A-3C. FIG. 3A shows a cross-sectional side view of an example forming tool 300, in which a portion of the forming tool 300 has been depicted as being placed within a volume of a slurry 304 of a liquid and material elements. In some examples, the liquid may be water or another type of suitable liquid in which pulp material, e.g., paper, wood, fiber crops, bamboo, or the like, may be mixed into the slurry 304. The material elements may be, for instance, fibers of the pulp material. FIG. 3B shows a cross-sectional side view of the transfer tool 320 and FIG. 3C shows a cross-sectional side view of the forming tool 300 and the transfer tool 320 during a dewatering and transfer process by the transfer tool 320 of the wet part 302 from the forming tool 300. The forming tool 300 and the transfer tool 320 may collectively form a pulp molding tool set.

As shown in FIG. 3A, the forming tool 300 may include a forming mold 306 and a forming screen 308, in which the forming screen 308 may overlay the forming mold 306. As shown in FIG. 3B, the transfer tool 320 may include a transfer mold 322 and a transfer screen 324. As discussed herein, some or all of the forming mold 306, the forming screen 308, the transfer mold 322, and the transfer screen 324 may be fabricated as separate portions 220, 222. In addition, the separate portions 220, 222 may be attached together through use of adhesives, mechanical fasteners, welding, mating mechanical features, and/or the like. FIGS. 3A and 3B depict the components 208 following attachment of the portions 220, 222.

In some examples, the forming mold 306 and/or the transfer mold 322 may be removably mounted onto respective supporting structures (not shown) such that, for instance, the forming mold 306 may be moved independently from the transfer mold 322. Moreover, the forming mold 306 and the forming screen 308 may be fabricated to have shapes to which the wet part 302 may be molded when formed on the forming screen 308. Likewise, the transfer mold 322 and the transfer screen 324 may be fabricated to have shapes that may engage multiple surfaces of the wet part 302 formed on the forming screen 308. The transfer screen 324 may have a shape that is complementary to the shape of the forming screen 308.

As also shown in FIGS. 3A-3C, the forming mold 306 and the transfer mold 322 may respectively include holes 310, 326 and the forming screen 308 and the transfer screen 324 may respectively include pores 312, 328 that may extend completely through respective top and bottom surfaces of the forming mold 306, the forming screen 308, the transfer mold 322, and the transfer screen 324. The pores 312, 328 may be significantly smaller than the holes 310, 326. In addition, a plurality of structural features, such as pillars 330 (shown in FIG. 3D) may be provided between the surfaces of the forming mold 306 and the forming screen 308 and between the transfer mold 322 and the transfer screen 324 that are respectively adjacent and face each other to enable liquid to flow laterally between the forming mold 306 and the forming screen 308 and between the transfer mold 322 and the transfer screen 324 as denoted by the arrow 314. As some of the pores 312 in the forming screen 308 may not directly align with the pores 312 in the forming mold 306 and some of the pores 328 in the transfer screen 324 may not directly align with the pores 328 in the transfer mold 322, the channels 332 formed by the structural features may enable liquid to flow through those pores 312, 328 in addition to the pores 312, 328 that are directly aligned with respective the holes 310, 326.

Although not shown, the forming tool 300 may be in communication with a plenum to which a vacuum source may be connected such that the vacuum source may apply a vacuum pressure through the holes 310 and the pores 312 in the forming mold 306 and the forming screen 308. When the vacuum pressure is applied through the holes 310 and the pores 312, some of the liquid in the slurry 304 may be suctioned through the holes 310 and the pores 312 and may flow into the plenum as denoted by the arrows 314. As the liquid flows through the holes 310 and the pores 312, the forming screen 308 may prevent the material elements in the slurry 304 from flowing through the pores 312. That is, the pores 312 may have sufficiently small dimensions, e.g., diameters or widths, that may enable the liquid to flow through the pores 312 while blocking the material elements from flowing through the pores 312. In one regard, the diameters or widths of the pores 312 may be sized based on sizes of the material elements, e.g., fibers, in the slurry 304. By way of particular example, the pores 312 may have diameters of around 0.6 mm. The pores 328 in the transfer screen 324 may also have similar diameters. However, in some instances, the pores 328 (as well as the pores 312) may have irregular shapes as may occur during 3D fabrication processes.

Over a period of time, which may be a relatively short period of time, e.g., about a few seconds, less than about a minute, less than about five minutes, or the like, the material elements may build up on the forming screen 308. Particularly, the material elements in the slurry 304 may be accumulated and compressed onto the forming screen 308 into the wet part 302. The wet part 302 may take the shape of the forming screen 308. In addition, the thickness and density of the wet part 302 may be affected by the types and/or sizes of the material elements in the slurry 304, the length of time that the vacuum pressure is applied while the forming mold 306 and the forming screen 308 are placed within the volume of the slurry 304, etc. That is, for instance, the longer that the vacuum pressure is applied while the forming mold 306 and the forming screen 308 are partially immersed in the slurry 304, the wet part 302 may be formed to have a greater thickness.

After a predefined period of time, e.g., after the wet part 302 having desired properties has been formed on the forming screen 308, the forming mold 306 and the forming screen 308 may be removed from the volume of slurry 304. For instance, the forming mold 306 may be mounted to a movable mechanism that may move away from the volume of slurry 304. In some examples, the movable mechanism may rotate with respect to the volume such that rotation of the movable mechanism may cause the forming mold 306 and the forming screen 308 to be removed from the volume of slurry 304. In other examples, the movable mechanism may be moved laterally with respect to the volume of slurry 304. As the forming mold 306 and the forming screen 308 are removed from the volume, some of the excess slurry 304 may come off of the wet part 302. However, the wet part 302 may have a relatively high concentration of liquid.

Following the formation of the wet part 302 on the forming screen 308 and movement of the forming screen 308 and the wet part 302 out of the volume of slurry 304, the transfer tool 320 may be moved such that the transfer screen 324 may contact the wet part 302 on the forming screen 308. That is, for instance, the transfer mold 322 may be attached to a movable mechanism (not shown), in which the movable mechanism may cause the transfer mold 306 and the transfer screen 324 to move toward the forming screen 308.

In addition, the transfer tool 320 may be in communication with a plenum to which a vacuum source may connected such that the vacuum source may apply a vacuum pressure through the holes 326 and the pores 328 while the wet part 302 is in contact with the transfer screen 324. The vacuum source may be the same or a different vacuum source to which the forming tool 300 may be in communication. Following the predefined length of time, the vacuum pressure applied through the forming tool 300 may be terminated or reversed (e.g., applied in the opposite direction) while vacuum pressure may be applied through the transfer tool 320 to facilitate transfer of the wet part 302 from the forming tool 300 to the transfer tool 320.

FIG. 3C shows a state in which the transfer tool 320 may be in the process of removing the wet part 302 from the forming screen 308. Particularly, in that figure, the transfer screen 324 has been moved into contact with the wet part 302 and a vacuum pressure has been applied onto the wet part 302 through the transfer screen 324. In addition, while the vacuum pressure is applied onto the wet part 302, the transfer tool 320 may be moved away from the forming tool 300 (or the forming tool 300 may be moved away from the transfer tool 320) to pull the wet part 302 off of the forming screen 308. To further facilitate removal of the wet part 302 from the forming screen 308, air pressure may be applied through the forming tool 300 as denoted by the arrows 334. As such, the wet part 302 may be biased toward the transfer tool 320 as opposed to being biased toward the forming tool 300. While the wet part 302 is biased toward the transfer tool 320, the transfer tool 320 may be moved away from the forming tool 300 such that the transfer tool 320 may remove the wet part 302 from the forming tool 300. In FIG. 3C, the forming tool 300 and the transfer tool 320 have been rotated 180º from their respective positions in FIGS. 3A and 3B. It should, however, be understood that the transfer mold 322 may remove the wet part 302 from the forming screen 308 while the forming tool 300 and the transfer tool 320 are in other orientations.

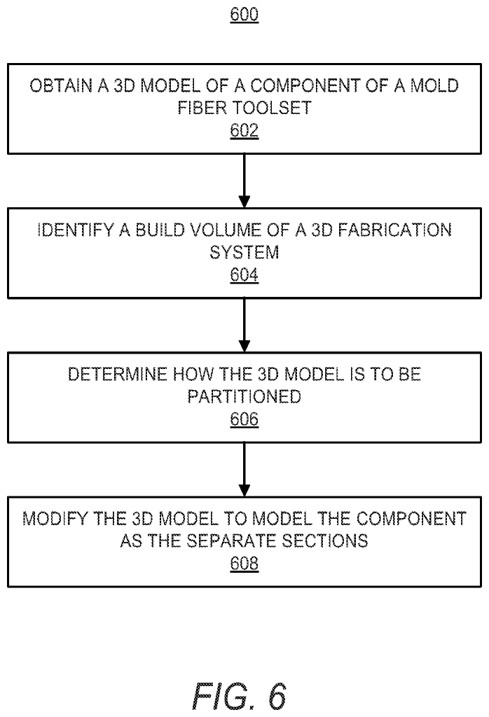

Turning now to FIG. 6, there is shown a flow diagram of an example method 600 for partitioning a 3D model 206 of a component 208 of a molded fiber toolset and modifying the 3D model 206 to model the component 208 as separate sections 216. It should be understood that the method 600 depicted in FIG. 6 may include additional operations and that some of the operations described therein may be removed and/or modified without departing from the scope of the method 600. The description of the method 600 is also made with reference to the features depicted in FIGS. 1-5 for purposes of illustration. In some examples, the processor 204 depicted in FIG. 2 may execute some or all of the operations included in the method 600.

At block 602, the processor 204 may obtain a 3D model 206 of a component 208 of a molded fiber toolset to be fabricated by a 3D fabrication system 210. At block 604, the processor 204 may identify a build volume 212 of the 3D fabrication system 210. At block 606, the processor 204 may determine how the 3D model 206 is to be partitioned into separate sections 216 while maximizing compliance with a set of factors 214 corresponding to the molded fiber toolset. The separate sections 216 may correspond to portions of the component 208 that are sized to be fabricated within the identified build volume 212 of the 3D fabrication system 210. In addition, at block 608, the processor 204 may modify the 3D model 206 to model the component 208 as the separate sections 216.

As discussed herein, the processor 204 may also determine whether the 3D fabrication system 210 is able to fabricate the component 208 as a whole within the build volume 212. In addition, the processor 204 may determine how the 3D model 206 is to be partitioned into the separate sections 216 based on a determination that the 3D fabrication system 210 is unable to fabricate the component 208 as a whole within the build volume 212.

According to examples, the processor 204 may obtain a second 3D model of a second component of the molded fiber toolset to be fabricated by the 3D fabrication system 210, in which the second component is to be mounted to the component 208. The processor 204 may determine how the second 3D model is to be partitioned into second separate sections while maximizing compliance with the set of factors 214, in which the second separate sections correspond to portions of the second component that are sized to be fabricated within the identified build volume 212 of the 3D fabrication system 210, In addition, the set of factors 214 may include a restriction on how the second 3D model is to be partitioned based on how the 3D model is determined to be partitioned. The processor 204 may also modify the second 3D model of the second component as the second separate sections of the second 3D model.

According to examples, the processor 204 may determine a plurality of candidate manners in which the 3D model 206 may be partitioned into the separate sections 216 based on the set of factors 214. The processor 204 may also output the determined plurality of candidate locations and may receive a selection of one of the plurality of candidate locations. The processor 204 may further modify the 3D model 206 of the component 208 according to the received selection.

Some or all of the operations set forth in the method 600 may be contained as utilities, programs, or subprograms, in any desired computer accessible medium. In addition, the method 600 may be embodied by computer programs, which may exist in a variety of forms. For example, the method 600 may exist as computer-readable instructions, including source code, object code, executable code or other formats. Any of the above may be embodied on a non-transitory computer readable storage medium.

Examples of non-transitory computer readable storage media include computer system RAM, ROM, EPROM, EEPROM, and magnetic or optical disks or tapes. It is therefore to be understood that any electronic device capable of executing the above-described functions may perform those functions enumerated above.

Although described specifically throughout the entirety of the instant disclosure, representative examples of the present disclosure have utility over a wide range of applications, and the above discussion is not intended and should not be construed to be limiting, but is offered as an illustrative discussion of aspects of the disclosure.

What has been described and illustrated herein is an example of the disclosure along with some of its variations. The terms, descriptions and figures used herein are set forth by way of illustration and are not meant as limitations. Many variations are possible within the scope of the disclosure, which is intended to be defined by the following claims—and their equivalents—in which all terms are meant in their broadest reasonable sense unless otherwise indicated.

What is claimed is:

1. A non-transitory computer-readable medium on which is stored machine-readable instructions that when executed by a processor, cause the processor to:
obtain a three-dimensional (3D) model of a component to be fabricated by a 3D fabrication system, the 3D fabrication system having a build volume;
determine, based on a set of factors, a partitioning of the 3D model into separate sections, wherein the separate sections correspond to portions of the component that are sized to be respectively or concurrently fabricated within the build volume; and
modify the 3D model to model the component as the separate sections.

2. The non-transitory computer-readable medium of claim 1, wherein the instructions cause the processor to:
determine whether the 3D fabrication system is able to fabricate the component as a whole within the build volume; and
determine the partitioning of the 3D model into the separate sections based on a determination that the 3D fabrication system is unable to fabricate the component as a whole within the build volume.

3. The non-transitory computer-readable medium of claim 1, wherein the component comprises a component of a molded fiber toolset, and wherein the set of factors comprise factors directed to the component of the molded fiber toolset and/or a mounting platen of the molded fiber toolset.

4. The non-transitory computer-readable medium of claim 3, wherein the set of factors comprise a type of slurry from which objects are to be formed on the molded fiber toolset.

5. The non-transitory computer-readable medium of claim 3, wherein the instructions cause the processor to:
obtain a second 3D model of a second component of the molded fiber toolset to be fabricated by the 3D fabrication system, wherein the second component is to be mounted to the component;
determine, based on the set of factors, a partitioning of the second 3D model into second separate sections, wherein the set of factors comprise a restriction on the partitioning of the second 3D model based on the partitioning of the 3D model; and
modify the second 3D model to model the second component as the second separate sections of the second 3D model.

6. The non-transitory computer-readable medium of claim 1, wherein the set of factors comprise factors directed to an ability of the portions to be fabricated in a nesting arrangement within the build volume of the 3D fabrication system.

7. The non-transitory computer-readable medium of claim 1, wherein the instructions cause the processor to:
determine a plurality of candidate partitioning locations of the 3D model based on the set of factors;
output the determined plurality of candidate partitioning locations;
receive a selection of one of the plurality of candidate partitioning locations; and
modify the 3D model of the component according to the received selection.

8. The non-transitory computer-readable medium of claim 1, wherein the set of factors follow a hierarchy of importance, and wherein the instructions cause the processor to:
determine the partitioning of the 3D model to maximize compliance with the set of factors according to the hierarchy of importance of the set of factors.

9. The non-transitory computer-readable medium of claim 1, wherein the instructions cause the processor to:
cause the 3D fabrication system to fabricate portions of the component corresponding to the separate sections based on the modified 3D model.

10. A method comprising:
obtaining, by a processor, a 3D model of a component of a molded fiber toolset to be fabricated by a 3D fabrication system;
identifying, by the processor, a build volume of the 3D fabrication system;
determining, by the processor, how the 3D model is to be partitioned into separate sections while maximizing compliance with a set of factors corresponding to the molded fiber toolset, wherein the separate sections correspond to portions of the component that are sized to be fabricated within the identified build volume of the 3D fabrication system; and
modifying, by the processor, the 3D model to model the component as the separate sections.

11. The method of claim 10, further comprising:
determining whether the 3D fabrication system is able to fabricate the component as a whole within the build volume; and
determine how the 3D model is to be partitioned into the separate sections based on a determination that the 3D fabrication system is unable to fabricate the component as a whole within the build volume.

12. The method of claim 10, further comprising:
obtaining a second 3D model of a second component of the molded fiber toolset to be fabricated by the 3D fabrication system, wherein the second component is to be mounted to the component;
determining how the second 3D model is to be partitioned into second separate sections while maximizing compliance with the set of factors, wherein the second separate sections correspond to portions of the second component that are sized to be fabricated within the identified build volume of the 3D fabrication system, wherein the set of factors comprise a restriction on how the second 3D model is to be partitioned based on how the 3D model is determined to be partitioned; and
modifying the second 3D model of the second component as the second separate sections of the second 3D model.

13. The method of claim 10, further comprising:
determining a plurality of candidate manners in which the 3D model is to be partitioned into the separate sections based on the set of factors;
outputting the determined plurality of candidate locations;
receiving a selection of one of the plurality of candidate locations; and
modifying the 3D model of the component according to the received selection.

14. A three-dimensional (3D) fabrication system comprising:
a build volume;
fabrication components; and
a controller to:
receive a 3D model including sections representing portions of a component of a molded fiber toolset, wherein the sections representing the portions of the component were partitioned to maximize compliance with a set of factors corresponding to the molded fiber toolset; and
control the fabrication components to fabricate the portions of the component separately from each other within the build volume based on the received 3D model, wherein the portions of the component are to be attached to each other to form the component of the molded fiber toolset following fabrication of the portions.

15. The 3D fabrication system of claim 14, wherein the controller is to:
receive a second 3D model including second sections representing second portions of a second component of the molded fiber toolset that is to be mounted to the component, wherein a partition location of the second portions do not overlap with a partition location of the portions of the component when the second component is mounted to the component.
